(19) United States
(12) Patent Application Publication
(10) Pub. No.: US 2010/0080236 A1
(43) Pub. Date: Apr. 1, 2010

(54) NEXT GENERATION AIRCRAFT RADIOS ARCHITECTURE (NGARA)

(75) Inventor: Walid S. Shawbaki, Columbia, MD (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/240,789

(22) Filed: Sep. 29, 2008

(51) Int. Cl. H04L 12/56

(52) U.S. Cl. 370/400

(57) ABSTRACT

An aircraft radio architecture is provided. The aircraft radio architecture includes a processing subsystem, a network subsystem communicatively coupled to the processing subsystem, and a radio front end communicatively coupled to the processing subsystem via network connectivity and the network subsystem. The processing subsystem includes a storage and processing medium to hold and process aeronautical radio software. The network subsystem is housed in a common computing cabinet with the processing subsystem. The network connectivity is configured to send digital messages for commanding and reconfiguring the radio front end for different functions and modes of operation.

### BACKGROUND

The application software in currently available aeronautical radio systems is heavily partitioned to meet the integrity and airworthiness requirements of aircraft. Each partition represents a radio function (i.e., very high frequency data link (VDL)) that is used to command the re-configurable radio for functions and different modes of operation. There are several issues related to the portioning of the application software in currently available aeronautical radio systems.

Current aeronautical radios deployed for communication (C), navigation (N), and surveillance (S) functions are characterized by: dedicated hardware and software architectures for single use functions; a stove pipe aeronautical radio architecture for communication, navigation, and surveillance (CNS) functions with multiple antennas to support redundancy; diverse part numbers to manage; interoperability/compliance problems to regional requirements; expensive to upgrade and reconfigure for new functions; limited growth to meet the evolving communication, navigation, and surveillance (CNS)/air traffic management (ATM) requirements; new and legacy functions are beginning to overwhelm ability to fit within a single line replaceable unit (LRU); and extensive parameter routing/interfaces for different functions with an aircraft system architecture. Currently available aeronautical radio system configurations for use in aircraft are built around duplication of the same radios for “just in case” situations.

The portioned application software each operating on a separate operating system contributes to the growth in overall volume (size), weight, and power consumption of LRU's in aircraft. In addition multiple aeronautical radios have their own associated antennas and cabling, both of which add weight. The addition of antennas introduces drag on an aircraft.

### SUMMARY

The present invention relates to an aircraft radio architecture. The aircraft radio architecture includes a processing subsystem, a network subsystem communicatively coupled to the processing subsystem, and a radio front end communicatively coupled to the processing subsystem via network connectivity and the network subsystem. The processing subsystem includes a storage and processing medium to hold and process aeronautical radio software. The network subsystem is housed in a common computing cabinet with the processing subsystem. The network connectivity is configured to send digital messages for commanding and reconfiguring the radio front end for different functions and modes of operation.

### DRAWINGS

FIG. 1 is a block diagram of one embodiment of an aircraft radio architecture in accordance with the present invention.

FIG. 2 is a diagram of functions and modes of operation of a radio front end commanded and configured by embodiments of a processing subsystem in accordance with the present invention.

FIG. 3 is a block diagram of one embodiment of an aircraft radio architecture in accordance with the present invention.

FIGS. 4A and 4B are diagrams of embodiments of common computing cabinets and radio front ends in an aircraft in accordance with the present invention.

In accordance with common practice, the various described features are not drawn to scale but are drawn to emphasize features relevant to the present invention. Like reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

The Next Generation Aircraft Radio Architecture (NGARA) is reconfigurable systems implemented in an aeronautical radio that satisfy the needs for multi-functions and multi-mode operation on aircraft. NGARA provides “radio on demand” per phase of flight, which offers benefits over the currently available aeronautical radio system configurations built around duplication of the same radios for “just in case” situations. As stated above, duplication of radios in the currently available aeronautical radio systems increases the size, weight, and power consumption on an aircraft. In this document, a radio architecture that consolidates of the application software to run with a single operating system is described. The radio architecture described herein improves the availability/disputability, redundancy, and safety of aircraft implementing the radio architecture. The radio architecture described herein saves space, reduces system size (volume), and removes the complexity of having to duplicate hardware and operating systems for all the different applications. In embodiments described herein, the application software is consolidated in a Next Generation Aircraft Radio Architecture to run with a single operating system. Embodiments of the aeronautical radio applications described herein include at least one of communication (COM) functions and modes, navigation (NAV) functions and modes, and surveillance (SURV) functions and modes.

The term application software as defined herein includes computer instructions that are residing external to radio hardware, such as NGARA hardware, in a common computing module and that are executed by processors within the aircraft to provide various functions and modes of aeronautical radio operation.

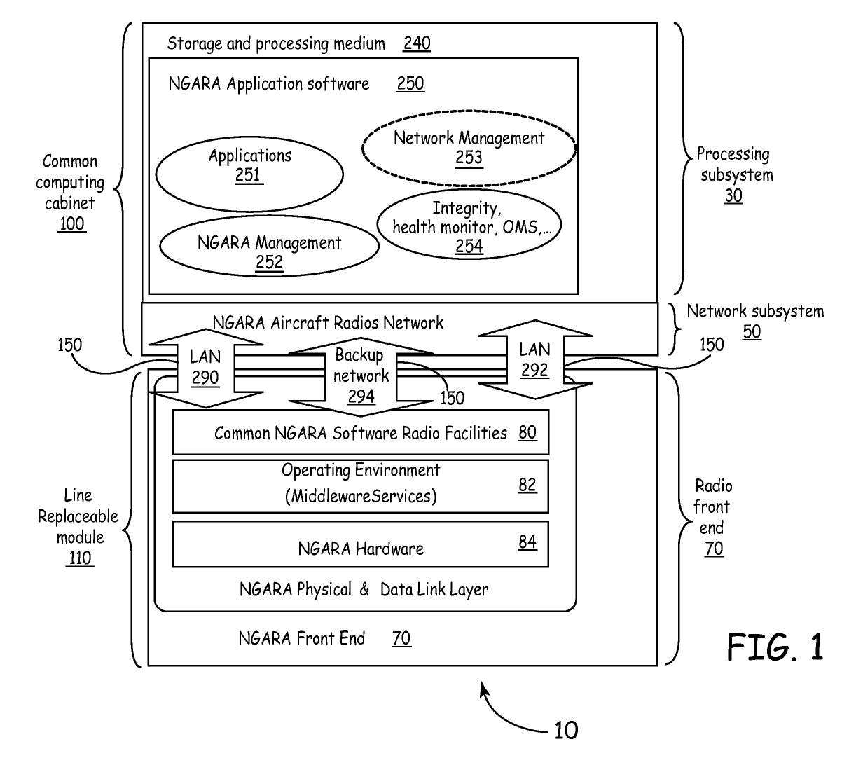

FIG. 1 is a block diagram of one embodiment of an aircraft radio architecture 10 in accordance with the present invention. The aircraft radio architecture 10 includes a processing subsystem 30, a network subsystem 50, and a radio front end 70. The network subsystem 50 is between the processing subsystem 30 and radio front end 70 so that the network subsystem 50 splits the radio front end 70 from the application software 250 (also referred to herein as “NGARA application software 250” and “aeronautical radio software 250”) in the processing subsystem 30. As shown in FIG. 1, the network subsystem 50 and the processing subsystem 30 are housed in a common computing cabinet 100 and the radio front end 70 is housed in a line replaceable module 110, also referred to herein as a “line replaceable unit 110.” In embodiments, the radio front end 70 is housed in other structures. In one implementation of this embodiment, the network subsystem 50 is between the processing subsystem 30 and radio front end 70 to separate them, although they are all enclosed in a common cabinet.

The processing subsystem 30 includes storage and processing medium 240 to hold and process the aeronautical radio software 250. The aeronautical radio software 250 is executed by processors in the aircraft in which the aircraft radio architecture 10 is implemented. The network subsystem 50 is communicatively coupled to the processing subsystem 30. The radio front end 70 is communicatively coupled to the processing subsystem 30 via network connectivity 150 and the network subsystem 50. The radio front end 70 includes the physical and data link layer of the aircraft radio architecture 10.

The network connectivity 150 is shown in FIG. 1 as the local area networks (LAN) 290 and 292 and the backup network 294. The network connectivity 150 is configured to send digital messages for commanding and reconfiguring the radio front end 70 for different functions and modes of operation. The local area networks (LAN) 290 and 292 can be implemented in a redundant manner. In one implementation of this embodiment, the network connectivity 150 includes one local area network, such as local area network 290 and the backup network 294.

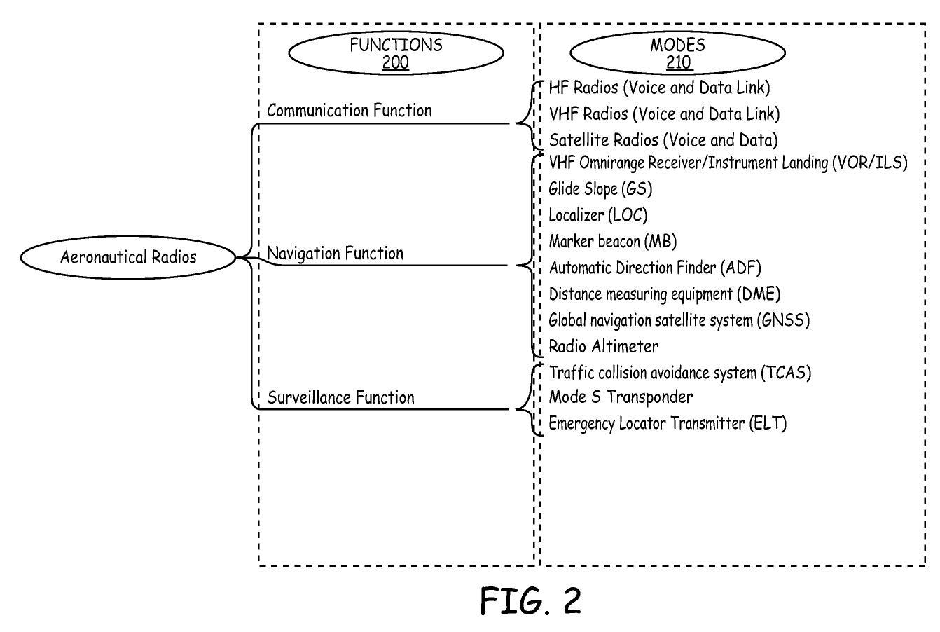

FIG. 2 is a diagram of functions 200 and modes 210 of operation of the radio front end 70 commanded and configured by embodiments of a processing subsystem 30 in accordance with the present invention. The functions include the communication function, the navigation function and the surveillance function.

The modes of operation in the communication function include voice and data links for High Frequency (HF) radios, voice and data links for Very High Frequency (VHF) radios, voice and data links for satellite radios. The modes of operation in the navigation function include VHF omnirange receiver/instrument landing system (VOR/ILS), glide slope (GS), localizer (LOC), marker beacon (MB), automatic direction finder (ADF), distance measuring equipment (DME), global navigation satellite system (GNSS), and radio altimeter. The modes of operation in the surveillance function include traffic collision avoidance system (TCAS), Mode S transponder, and emergency locator transmitter (ELT).

The aeronautical radio applications in the aeronautical radio software 250 comprise at least one of communication (COM) functions and modes, navigation (NAV) functions and modes, and surveillance (SURV) functions and modes. In the embodiment shown in FIG. 1, the NGARA application software 250 includes applications 251, NGARA management 252, network management 253, and software 254 for integrity, health monitoring, and onboard maintenance subsystem (OMS) for the radio architecture, as well as other software. The aircraft radio architecture 10 includes management applications that comprise at least one of: input/output for sensors; line replaceable module status and configuration control; antenna switching modules; and amplifiers per phase of flight. In embodiments, there is more software and/or other software. As shown in FIG. 1, the network subsystem 50 includes a NGARA aircraft radio network. In embodiments, the network subsystem 50 includes other types of networks. In one implementation of this embodiment, the storage and processing medium 240 holds and processes at least one of applications 251, NGARA management 252, network management 253, and other software 254.

The processing subsystem 30 is connected via the network subsystem 50 and network connectivity 150 to send control signals to the radio front end 70. The radio front end 70 includes software radio facilities 80, an operating environment 82, and hardware 84 (also referred to herein as “NGARA hardware 84”). The software radio facilities 80 are operable when communicatively coupled via the network connectivity 150 to the processing subsystem 30 housed in the common computing cabinet 100. The operating environment 82 is communicatively coupled to the software radio facilities 80. The hardware 84 is communicatively coupled to the operating environment 82. The hardware 84 is configured for radio functionality and modes of operation, such as the functions 200 and modes 210 of operation shown in FIG. 2.

When the common computing cabinet 100 is communicatively coupled to the software radio facilities 80 via the network connectivity 150, the software 250 housed in the common computing cabinet 100 is operable to command and reconfigure the hardware 84. Specifically, the software 250 housed in the common computing cabinet 100 commands and reconfigures the hardware 84 using aeronautical radio applications, aircraft radio architecture management applications, network management applications, and monitoring applications.

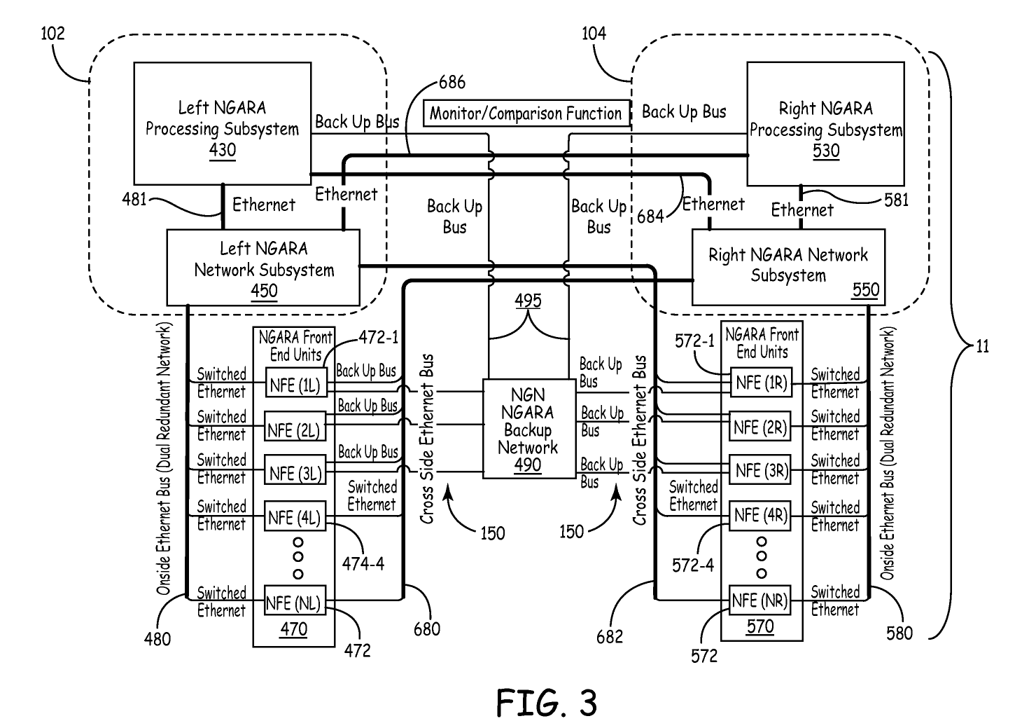

FIG. 3 is a block diagram of one embodiment of aircraft radio architecture 11 in accordance with the present invention. The common computing cabinet 100 is configured with a left (L) and right (R) configuration for an aircraft. The processing subsystem includes a left processing subsystem 430 (also referred to herein as “left NGARA processing subsystem 430”) and a right processing subsystem 530 (also referred to herein as “right NGARA processing subsystem 530”). The network subsystem includes a left network subsystem 450 (also referred to herein as “left NGARA network subsystem 430”) and a right network subsystem 550 (also referred to herein as “right NGARA network subsystem 530”). The left radio front end 470 (also referred to herein as “NGARA front end units 470”) includes redundant radio front end units 472(1-N). Likewise, the right front end 470 (also referred to herein as “NGARA front end units 570”) includes redundant radio front end units 572(1-N).

The left processing subsystem 430 is housed with a left network subsystem 450 in a first common computing cabinet 102 and the right processing subsystem 530 is housed with a right network subsystem 550 in a second common computing cabinet 104. The left processing subsystem 430 and the right processing subsystem 530 each hold redundant sets of aeronautical radio software. Specifically, the network management applications in the left processing subsystem 430 and the right processing subsystem 530 include at least one of redundancy, fault tolerance, reversionary, and back up modes.

The first common computing cabinet 102 houses the aeronautical radio functions and modes application software (shown as 251-254 in FIG. 1) for different functions and modes, such as the functions 200 and the modes 210 shown in FIG. 2, while the second common computing cabinet 104 houses the aeronautical radio functions and modes application software (shown as 251-254 in FIG. 1) for different functions and modes, such as the functions 200 and the modes 210 shown in FIG. 2. The right processing subsystem 530 is a redundant subsystem of the left processing subsystem 430. The right network subsystem 550 is a redundant subsystem of the left network subsystem 450.

The network connectivity includes a redundant connection between at least one redundant front end unit 470 or 570 and one redundant set of aeronautical radio software in processing subsystem 430 or processing subsystem 530. The network connectivity represented generally at 150 includes a left onside bus 480, a left onside connection 481, a right onside bus 580, a right onside connection 581, a first cross-side bus 680, a first cross-side connection 684, a second cross-side bus 682, and a second cross-side connection 686. The network subsystem 50 of FIG. 1 includes the left NGARA network subsystem 450 and the right NGARA network subsystem 550.

The left NGARA network subsystem 450 and right NGARA network subsystem 550, are each interfaced to the right processing subsystem 430 and the left processing subsystem 430 and are each operational in a fully redundant manner. The left radio front end 470 includes at least one left radio front end unit 472-i, where i indicates the ith left radio front end, that is communicatively coupled to the left processing subsystem 430 and the right processing subsystem 530 by both the left network subsystem 450 and the right network subsystem 550. The right radio front end 570 includes at least one right radio front end unit 572-i, where i indicates the ith right radio front end, that is communicatively coupled to the left processing subsystem 430 and the right processing subsystem 530 by both the left network subsystem 450 and the right network subsystem 550.

Specifically, the network connectivity 150 is configured so that: the left onside bus 480 communicatively couples the left radio front end units 472(1-N) in the left radio front end 470 to the left network subsystem 450; the left onside connection 481 communicatively couples the left network subsystem 450 to the left processing subsystem 430; the right onside bus 580 communicatively couples the right radio front end units 572(1-N) in the right radio front end 570 to the right network subsystem 550; and the right onside connection 581 communicatively couples the right network subsystem 550 to the right processing subsystem 530; the first cross-side bus 680 communicatively couples the left radio front end units 472(1-N) in the left radio front end 470 to the right network subsystem 550; the first cross-side connection 684 communicatively couples the right network subsystem 550 to the left processing subsystem 430; the second cross-side bus 682 communicatively couples the right radio front end units 572(1-N) in the right radio front end 570 to the left network subsystem 450; and the second cross-side connection 686 communicatively couples the left network subsystem 450 to the right processing subsystem 530. In this manner, the network connectivity 150 and the network subsystems 450 and 550 provide a redundant connection between at least dual/dual redundant front end units 470 and 570 and one redundant set of aeronautical radio application software in the processing subsystems 430 and 530.

The aircraft radio architecture 11 also includes a backup network 490 (also referred to herein as “NGARA backup network 490”) that communicatively couples the radio front end 470 and radio front end 570 to the left processing subsystem 430 and the right processing subsystem 530 via communication links represented generally at 495.

In one implementation of this embodiment, the left onside bus 480, the right onside bus 580, the left cross-side bus 680, the right cross-side bus 682, the left onside connection 481, the right onside connection 581, the first cross-side connection 684, and the second cross-side connection 686 are Ethernet connections.

Thus as shown herein, the common computing cabinet houses the aeronautical radios application software for the different functions and modes. Redundancy and backup networks provide the whole networking architecture. The redundant and backup networks are each interfaced to the common computing cabinet and each work in fully redundant fashion. In one implementation of this embodiment, the radio front end comprises redundant radio front end units. In one such implementation, the at least one redundant front end unit is a dual/dual redundant front end unit. In this case, the network connectivity comprises a redundant connection is dual/dual redundant connection that comprises at least two local area networks and a backup network for an emergency communication link. The backup network is a subset of the network that commands a minimum set of radios for an emergency communication link.

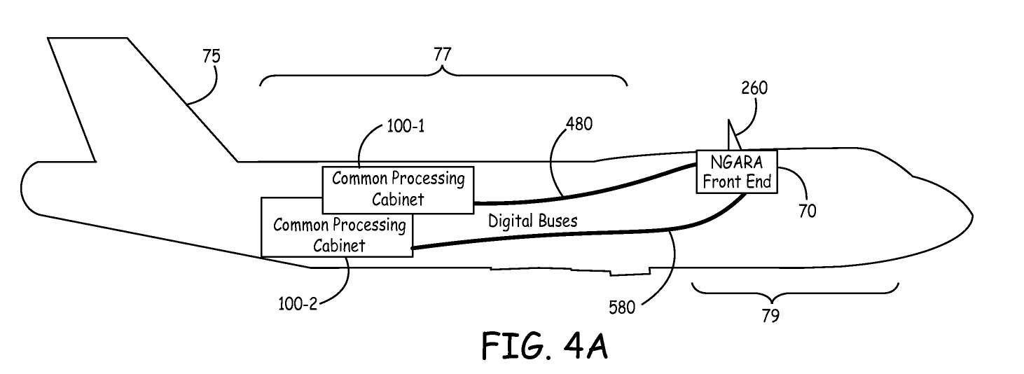

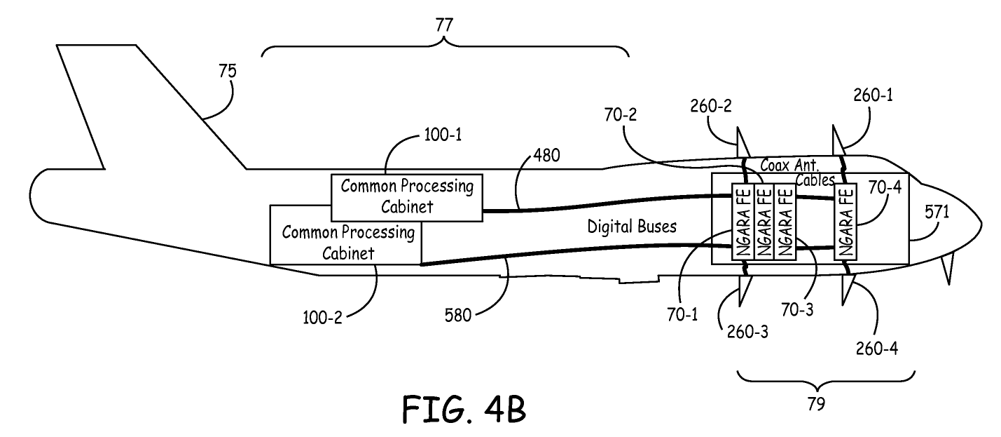

FIGS. 4A and 4B are diagrams of embodiments of common computing cabinets 100(1-2) and radio front ends 70 (FIG. 1) in an aircraft 75 in accordance with the present invention. As shown in FIG. 4A, two common computing cabinets 100(1-2) are in a midsection 77 of the aircraft 75 and are communicatively coupled to a single NGARA front end 70, via digital buses, such as buses 480 and 580 (FIG. 3). The antenna 260 is communicatively coupled to the NGARA front end 70. As shown in FIG. 4B, two common computing cabinets 100(1-2) are in the midsection 77 of the aircraft 75 and are communicatively coupled to a plurality of NGARA front ends 70(1-4) that are housed in a front end cabinet 571. The two common computing cabinets 100(1-2) are communicatively coupled via digital buses, such as buses 480 and 580 (FIG. 3) to the plurality of NGARA front ends 70(1-4). There are four antennas 260(1-4) communicatively coupled via coax cable to respective ones of the four NGARA front ends 70(1-4). In this manner, the NGARA front ends 70 are separated physically from the common computing cabinets so that the NGARA front ends 70 are close to the antennas 260 near the cockpit 79 of the aircraft 75 and the common computing cabinets are distanced from the antennas 70(1-4).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. An aircraft radio architecture, comprising:
a processing subsystem, the processing subsystem including a storage and processing medium to hold and process aeronautical radio software;
a network subsystem communicatively coupled to the processing subsystem and housed in a common computing cabinet with the processing subsystem; and
a radio front end communicatively coupled to the processing subsystem via network connectivity and the network subsystem, wherein the network connectivity is configured to send digital messages for commanding and reconfiguring the radio front end for different functions and modes of operation.

2. The aircraft radio architecture of claim 1, wherein the processing subsystem holds redundant sets of the aeronautical radio software that each include aeronautical radio functions and modes application software, wherein the radio front end includes at least two radio front end units, wherein the network connectivity includes a redundant connection between the at least two front end units and the redundant sets of aeronautical radio functions and modes application software.

3. The aircraft radio architecture of claim 2, wherein the redundant connection comprises at least two local area networks and a backup network, the backup network configured to transmit digital messages via an emergency communication link.

4. The aircraft radio architecture of claim 1, wherein the processing subsystem comprises:
a left processing subsystem housed with a left network subsystem in a first common computing cabinet housing the aeronautical radio functions and modes application software for different functions and modes; and
a right processing subsystem housed with a right network subsystem in a second common computing cabinet housing the aeronautical radio functions and modes application software for different functions and modes, the right processing subsystem being a redundant subsystem of the left processing subsystem, the right network subsystem being a redundant subsystem of the left network subsystem, wherein at least two local area networks are each interfaced to the right processing subsystem and the left processing subsystem and are each operational in a fully redundant manner.

5. The aircraft radio architecture of claim 4, wherein the radio front end comprises:
a left radio front end unit being communicatively coupled to the left processing subsystem and the right processing subsystem by both the left network subsystem and the right network subsystem; and
a right radio front end unit being communicatively coupled to the left processing subsystem and the right processing subsystem by both the left network subsystem and the right network subsystem.

6. The aircraft radio architecture of claim 5, wherein the network connectivity includes,
a left onside bus to communicatively couple the left radio front end unit to the left network subsystem;
a left onside connection to communicatively couple the left network subsystem to the left processing subsystem;
a right onside bus to communicatively couple the right radio front end unit to the right network subsystem; and
a right onside connection to communicatively couple the right network subsystem to the right processing subsystem.

7. The aircraft radio architecture of claim 6, wherein the network connectivity further includes,
a first cross-side bus to communicatively couple the left radio front end unit to the right network subsystem;
a first cross-side connection to communicatively couple the right network subsystem to the left processing subsystem;
a second cross-side bus to communicatively couple the right radio front end unit to the left network subsystem; and
a second cross-side connection to communicatively couple the left network subsystem to the right processing subsystem.

8. The aircraft radio architecture of claim 7, wherein the left onside bus, the right onside bus, the left cross-side bus, the right cross-side bus, the left onside connection, the right onside connection, the first cross-side connection, and the second cross-side connection are Ethernet connections.

9. The aircraft radio architecture of claim 1, further comprising a monitor/comparison function.

10. The aircraft radio architecture of claim 1, wherein processing subsystem holds next generation aeronautical radio software, wherein the radio front end is configured for next generation aeronautical radio functions and next generation aeronautical radio modes of operation.

11. The aircraft radio architecture of claim 1, wherein the network subsystem comprises at least one local area network and a backup communication link.

12. A common computing cabinet housing a processing subsystem and a network subsystem, the processing subsystem configured to hold software comprising aeronautical radio applications, aircraft radio architecture management applications, network management application, monitoring applications, the processing subsystem connected via the network subsystem and network connectivity to send control signals to a radio front end.

13. The common computing cabinet of claim 12, wherein the aeronautical radio applications comprise at least one of communication (COM) functions and modes, navigation (NAV) functions and modes, and surveillance (SURV) functions and modes.

14. The common computing cabinet of claim 12, wherein the aircraft radio architecture management applications comprise at least one of: input/output for sensors; line replaceable module status and configuration control; antenna switching modules; and amplifiers per phase of flight.

15. The common computing cabinet of claim 12, wherein the processing subsystem comprises a left processing subsystem and a right processing subsystem, wherein the network subsystem comprises a left network subsystem and a right network subsystem, and wherein the network management application comprises at least one of redundancy, fault tolerance, reversionary, and back up modes.

16. The common computing cabinet of claim 12, wherein the radio front end is housed in a line replaceable module.

17. A radio front end, comprising:
software radio facilities that are operable when communicatively coupled via a network connectivity to a processing subsystem holding software, the processing subsystem housed in a common computing cabinet;
an operating environment communicatively coupled to the software radio facilities; and
hardware configured for radio functionality, the hardware communicatively coupled to the operating environment, wherein when the common computing cabinet is communicatively coupled to the software radio facilities via the network connectivity, the software in the processing subsystem is operable to command and reconfigure the hardware.

18. The radio front end of claim 17, wherein the software housed in the common computing cabinet to command and reconfigure the hardware comprises: aeronautical radio applications; aircraft radio architecture management applications; network management application; and monitoring applications.

19. The radio front end of claim 17, wherein the network connectivity is configured to send digital messages for commanding and for reconfiguring the radio front end for different functions and modes of operation.

20. The radio front end of claim 17, wherein the radio front end comprises redundant radio front end units, wherein the processing subsystem holds redundant sets of aeronautical radio software, and wherein the network connectivity comprises a redundant connection between at least one redundant front end unit and one redundant set of aeronautical radio software.
